(19) United States
(12) Patent Application Publication
(10) Pub. No.: US 2017/0337653 A1
(43) Pub. Date: Nov. 23, 2017

(54) SYSTEM AND METHOD FOR ASSESSING INDIVIDUAL AFFINITY FOR VIOLENCE OR EXTREMISM

(71) Applicant: Versive Ventures, LLC, La Jolla, CA (US)

(72) Inventor: Mark Ellis, La Jolla, CA (US)

(73) Assignee: Versive Ventures, LLC, La Jolla, CA (US)

(21) Appl. No.: 15/445,749

(22) Filed: Feb. 28, 2017

Related U.S. Application Data
(63) Continuation-in-part of application No. 14/864,150, filed on Sep. 24, 2015.
(60) Provisional application No. 62/300,834, filed on Feb. 28, 2016.

(51) Int. Cl. G06Q 50/26; G06F 17/30; G06F 3/0482; G06F 3/0489

(52) U.S. Cl. CPC G06Q 50/265; G06F 17/30598; G06F 3/0482; G06F 3/0489

(57) ABSTRACT

The subject matter disclosed herein provides methods for assessing potential safety and security risks by measuring a test subject's implicit affinity for violence or extremism. A series of sorting tasks can be generated for a user of a computer associated with a machine. At least two digital representations of association categories can be provided. A sequence of two or more trials can be executed. Each trial can provide a randomly-selected digital representation of a stimulus that can provide at least two digital representations of association categories; receive a selection by the user in response to the stimulus; and record a time between providing the randomly-selected digital representation of the stimulus and receiving the selection by the user. A score can be calculated reflecting the strength of the user's implicit association between one pair of identity-related and violence- or extremism-related categories and a different pair. Related apparatus, systems, techniques, and articles are also described.

### TECHNICAL FIELD

The subject matter described herein relates to computer-implemented testing, and more particularly to a computer-implemented system and method for ascertaining potential risks to public security and safety arising from violence or extremism by measuring a test subject's implicit affinity for violence or extremism.

### BACKGROUND

Government agencies responsible for defense, law enforcement, intelligence, immigration, and other security-related areas frequently need to vet accurately and quickly the backgrounds, intentions, and loyalties of people they interact with, such as in a criminal investigation, screening refugees and other immigrants, screening candidates for positions with potential security or safety vulnerabilities, or assessing the eligibility and progress of participants in de-radicalization programs. Existing vetting processes generally consist of background checks and interviews, which have a number of well-known gaps and shortcomings in identifying individuals posing potential safety and security risks, who frequently wish to conceal, obfuscate, or manipulate information about their identities, activities, and affiliations.

These gaps and shortcomings include:
1. Inadequate identification
   a. No identification documents (e.g., passport)
   b. Forged, stolen, or altered identification documents
2. Insufficient or inaccurate background data
   a. No background data collected for given name (e.g., no police record)
   b. Database mismatch
      i. Multiple people with same name, place of residence, and other identifying characteristics
      ii. Name transliteration errors
   c. Data quality: inadequate, inaccurate, incorrect, forged, etc.
3. High process volume: number of screeners insufficient for the volume of people to be screened (e.g., processing refugees, recruiting militias)
4. Poor process quality
   a. Interviews require highly trained and experienced personnel
   b. Subjects can lie, obfuscate, or otherwise provide inaccurate or misleading information
   c. Results are highly subjective and sensitive to screener biases, mood, previous experience, etc.
   d. Validity/reliability of interviews as a screening mechanism is very poor, in general
5. Agency: screening is often out-sourced to people or organizations who may have conflicts of interest, inadequate training, suspect loyalties, or minimal “skin in the game”

To address these numerous deficiencies of existing approaches, a screening method is needed that meets the following criteria and objectives:
1. Can ascertain a subject's potential threat with little or no information beyond what is collected by the assessment;
2. Can be conducted in real-time;
3. Clearly links the screen results with the individual being screened;
4. Is quick and easy to administer;
5. Requires little training to administer;
6. Provides an unambiguous assessment that is not subject to the judgment of the screener; and
7. Provides accurate results, especially few false negatives when identifying potential threats.

One approach to security screening that meets these criteria is to assess the subject's implicit cognition—unconscious attitudes and beliefs that can strongly influence behavior. Over the last two decades, psychologists have developed both a detailed understanding of implicit cognition and a number of methods to assess implicit attitudes and beliefs. These assessments have two key advantages over explicit approaches, such as questionnaires and interviews: (1) they can reveal attitudes and beliefs that the subject may not be aware of; and (2) they are immune to faking, so they provide reliable results in cases where the subject is aware but does not wish to reveal the attitudes and beliefs being assessed. When the attitudes and beliefs being assessed are socially sensitive (e.g., prejudice, intention to harm oneself or others, attitudes toward one's spouse), assessments of implicit cognition have been shown to be better predictors of future behavior than conventional approaches, including questionnaires, interviews, aptitude tests, and even professional clinical assessment.

The most studied and accurate among implicit cognition assessments is the Implicit Association Test (TAT). The TAT provides a measure of a user's relative strengths of association between two sets of concepts, generally a target (e.g., “Us”, “Them”) and an evaluative attribute (e.g., “Not Extremism”, “Extremism”). To determine the relative strengths of association between the two sets of concepts, the user is asked in a series of trials to sort stimuli representative of each of the two targets and each of the two attributes, using a single response for the first target-attribute pair (e.g., “Us” or “Not Extremism”) and a different response for the second target-attribute pair (e.g., “Them” or “Extremism”). The response times for this first sorting exercise are recorded. A second block of sorting trials switches either the two target categories or the two attribute categories, such that one response is associated with the first target and second attribute (or second target and first attribute) categories, and the other response is associated with the second target and first attribute (or first target and second attribute) categories. The “TAT effect” (or score) is a function of the difference in the average response times for each of the two blocks of trials. The TAT has been shown to be highly resistant to preparation and socially desirable responding, and the TAT effect has demonstrated high validity in predicting behavior outside the test environment.

A test of an individual's implicit affinity for violence or extremism would be highly valuable in any setting in which such a tendency could pose a safety or security risk, such as in screening refugees and other immigrants; interviewing criminal suspects; evaluating candidates for employment in security-sensitive occupations (e.g., public transport, critical infrastructure, public safety); recruiting local fighters, intelligence sources, and other personnel during combat and peacekeeping missions; or deradicalization programs. The proposed “Affinity for Violence or Extremism Implicit Association Test” (AVE-IAT), an adaptation of the IAT methodology that overcomes the above-described weaknesses of existing screening approaches, is the first psychological test to assess, with high predictive validity and resistance to preparation and socially desirable responding, an individual's generalized affinity for violence or extremism.

### SUMMARY

In one aspect, a computer-implemented method and a computer system to execute a method are provided. The method includes generating, by one or more processors of a machine, a series of sorting tasks for a user of a computer associated with the machine, the computer including an output device and an input device, each of the series of sorting tasks comprising a plurality of digital representations of stimuli associated with either the user's identity or extremism. The method further includes providing, by the one or more processors, at least two digital representations of association categories as separate outputs from the output device, at least one of the at least two digital representations of the association categories being associated with the user's identity, and at least one other of the at least two digital representations of the association categories being associated with extremism, each of the separate outputs being associated with an input actuator of the input device.

The method further includes executing, by the one or more processors, a sequence of two or more trials. Each trial includes providing, by the one or more processors, a randomly-selected digital representation of a stimulus to the output device in proximity to the separate outputs that provide the at least two digital representations of the association categories, the stimulus being associated with either the user's identity or extremism represented by the at least two digital representations of the association categories. The execution of each trial further includes receiving, by the one or more processors, a selection by the user from the input actuator of the input device in response to the stimulus, the selection indicating a category with which the user associates the stimulus, and recording, by the one or more computer processors, a time between providing the randomly-selected digital representation of the stimulus and receiving the selection by the user via the input device.

The method further includes calculating, by the one or more computer processors, a score of the user's relative strength of association of at least two association categories of the user's identity or extremism with at least one association category of the other of the user's identity or extremism, the score being based at least partially on the time between providing the at least two randomly-selected digital representations of stimuli and receiving the selection by the user via the input device for each of the trials in the sequence of two or more trials.

Implementations of the current subject matter can include, but are not limited to, systems and methods consistent with the disclosure herein, as well as articles that comprise a tangibly embodied machine-readable medium operable to cause one or more machines (e.g., computers, etc.) to result in operations described herein. Similarly, computer systems are also described that may include one or more processors and one or more memories coupled to the one or more processors. A memory, which can include a computer-readable storage medium, may include, encode, store, or the like one or more programs that cause one or more processors to perform one or more of the operations described herein. Computer implemented methods consistent with one or more implementations of the current subject matter can be implemented by one or more data processors residing in a single computing system or multiple computing systems. Such multiple computing systems can be connected and can exchange data and/or commands or other instructions or the like via one or more connections, including but not limited to a connection over a communications network (e.g. the Internet, a wireless wide area network, a local area network, a wide area network, a wired network, or the like), via a direct connection between one or more of the multiple computing systems, etc.

The details of one or more variations of the subject matter described herein are set forth in the accompanying drawings and the description below. Other features and advantages of the subject matter described herein will be apparent from the description and drawings, and from the claims. While certain features of the currently disclosed subject matter are described for illustrative purposes in relation to an enterprise resource software system or other business software solution or architecture, it should be readily understood that such features are not intended to be limiting. The claims that follow this disclosure are intended to define the scope of the protected subject matter.

### DESCRIPTION OF DRAWINGS

The accompanying drawings, which are incorporated in and constitute a part of this specification, show certain aspects of the subject matter disclosed herein and, together with the description, help explain some of the principles associated with the disclosed implementations. In the drawings,

FIG. 1 is a block diagram of a system that executes a method as described herein;

FIG. 2(a) and FIG. 2(b) show illustrative Affinity for Violence or Extremism IAT combined task screen layouts;

FIG. 3 is an Affinity for Violence or Extremism IAT block and trial structure;

FIG. 4(a) and FIG. 4(b): Illustrative Affinity for Violence or Extremism Brief IAT combined task screen layouts;

FIG. 5: Affinity for Violence or Extremism Brief IAT block and trial structure;

FIG. 6(a) and FIG. 6(b): Illustrative Affinity for Violence or Extremism Single-Target IAT screen layouts;

FIG. 7(a) and FIG. 7(b): Illustrative Affinity for Violence or Extremism Single-Attribute IAT screen layouts;

FIG. 8: Affinity for Violence or Extremism Single-Target IAT block and trial structure;

FIG. 9: Affinity for Violence or Extremism Single-Attribute IAT block and trial structure;

FIGS. 10(a) and 10(b): Illustrative Affinity for Violence or Extremism Recoding-Free IAT combined task screen layouts;

FIG. 11(a) and FIG. 11(b): Affinity for Violence or Extremism Recoding-Free IAT block and trial structure;

FIG. 12(a) and FIG. 12(b): Illustrative Affinity for Violence or Extremism Single-Block IAT combined task screen layouts;

FIG. 13(a) and FIG. 13(b): Illustrate affinity for Violence or Extremism Single-Block IAT block and trial structure;

FIG. 14: Block response data used in conventional and D score algorithms under various IAT implementations.

FIG. 15: Shows illustrative stimuli in accordance with implementations described herein.

When practical, similar reference numbers denote similar structures, features, or elements.

### DETAILED DESCRIPTION

To address the shortcomings of currently available screening methods, one or more implementations of the current subject matter can, among other possible advantages, provide a system and method, article of manufacture, and the like, to accurately assess the strength of a person's affinity for violence or extremism.

The IAT has been developed to assess an individual's implicit beliefs and attitudes—those he or she may not be consciously aware of or, if he or she is, would not admit to, yet nonetheless strongly influence his or her behavior. The systems and methods described herein use the IAT in a new “affinity for violence or extremism” configuration to measure the strength of an individual's affinity for violence or extremism. As used herein, the term “extremism” includes an advocacy of or belief in extreme measures or views, particularly political, religious, or racial ideologies that are considered to be far outside the (acceptable) mainstream attitudes of a society.

A suitably-constructed TAT can be used to measure implicit attitudes toward violence or extremism, which can provide a more reliable indicator of an individual's safety or security risk than current methods. This can be done by modifying the TAT in a very novel and non-obvious way to measure the relative strengths of associations (i.e., speed of response) between target categories representing the test subject's identity (e.g., words or images representing “Me” or “Us”) and not-the-test-subject's-identity (e.g., words or images representing “Them” or “Not me”), and attribute categories representing extremism (e.g., in assessing affinity for violence or acts of terrorism, etc., such as images or words representing concepts such as the World Trade Center towers collapsing, Osama bin Laden's image, flags of various terrorist organizations, a black-masked soldier, etc.) and not-extremism (e.g., in assessing less or no affinity for violence or acts of terrorism, etc., such as images or words representing either anti-terrorist organizations or institutions, like the United States, or neutral concepts that have no association whatsoever with terrorism, like everyday items or nature).

An affinity for violence or extremism will manifest itself in faster response times when one response is required for stimuli representing the subject's identity and violence or extremism and the other response is required for not-the-subject's-identity and not-violence or not-extremism (the less common “incompatible” associations), than when one response is required for stimuli representing the subject's identity and not-violence or not-extremism and the other response is required for not-the-subject's-identity and violence or extremism (the more common “compatible” associations). By timing and recording the user's response latencies, a system and method can test and measure the relative strengths of associations between the subject's identity and violence or extremism and between the subject's identity and not-violence or not-extremism. Implicit associations like these have been shown to be reliable predictors of future behavior.

The system and method are designed to detect the strength of a person's automatic associations between different concepts. As executed, a method requires subjects to rapidly categorize two target concepts with an attribute (e.g., the targets “Us” and “Them” with the attributes “Not Extremism” and “Extremism”), such that easier pairings (faster responses) are interpreted as more strongly associated in memory than more difficult pairings (slower responses). Because the system requires that subjects make a series of rapid judgments, the scores reflect attitudes that people may not wish to reveal. Accordingly, the system and method are configured to get around social-desirability bias and assess subjects' implicit attitudes.

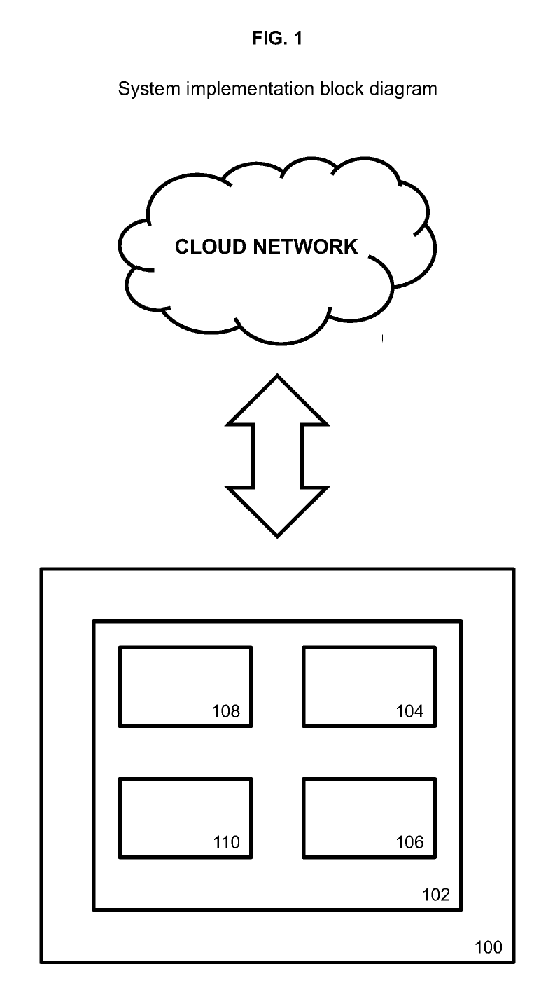

In accordance with preferred implementations, and as shown in FIG. 1, the method is executed and administered electronically on a system 100, which includes a computer 102. The computer 102 can be any terminal (i.e., where processing is done in a different device, such as a remote server), mobile device (smartphone or tablet), purpose-built device, or other computing device.

The computer 102 includes a display 104 to present the test-subject the stimuli to elicit a response, and provide instructions and other information and feedback needed to administer the test. The computer 102 further includes a processor 106 to execute the test, to register and time the subject's responses, to generate any other information needed by the subject to complete the test (e.g., instructions, feedback), and to process the subject's responses and calculate a score. The computer 102 further includes an electronic storage medium 108, which is embodied as a non-transient electronic storage medium (e.g., chip-, disk-, or tape-based) to record and store the subject's responses for later processing by the processor. The computer 102 also includes an electronic input mechanism 110 having at least two inputs for registering at least two different responses (e.g., left and right) and relaying the inputs to the processor 106. The electronic input mechanism 110 can be a keyboard, a keypad, a touchscreen, a switch, a mouse, a trackball, one or more paddles, push-buttons, and/or the like.

The system 100 includes program instructions that are stored on the electronic storage medium 108 and executable by the processor 106, to direct the display 104, processor 106, electronic storage medium 108, and electronic input device 110 to administer the test by presenting a subject with instructions, stimuli, and feedback on the display 104, and accepting input from the electronic input mechanism 110 for recording and storage in the electronic storage medium 108, as described in more detail below.

In accordance with some implementations, a method for testing for individual affinity for violence or extremism includes a series of tasks, organized into blocks of multiple trials. According to one exemplary implementation, execution of an “Affinity for Violence or Extremism IAT” begins with the presentation of instructions to the user. These instructions explain how the category headings and stimuli will be presented to the user, how the user inputs his or her responses, and how to respond when an error message is received following an incorrect input (the test does not proceed until the other, correct, response is entered). The instructions also list all the categories that will be used in the test and, if words are used, lists the stimuli in each category (if other stimuli, e.g., images, are used, they are described). Execution then proceeds through a series of seven tasks, generally as follows.

The first task is “target concept practice”. The test-taker is asked to sort target concept stimuli into categories representing the subject's identity (e.g., words related to the concept of “Us” or “Me”) and not-the-subject's identity (e.g., words related to the concept of “Them” or “Other”). On the display 104, the word “Us” (or a related word) appears in the upper left of the display 104 as a category heading, while the word “Them” (or a related word) appears in the upper right of the display 104. In the center of the display 104 appears a randomized sample from a group of stimuli (usually words, but potentially images, sounds or other computer-renderable stimuli) typically associated with the concepts of the user's identity (e.g., “Us”-related terms such as “We”, “Our”, “Ours” and/or “Me”-related terms, such as “I”, “My”, “Mine”) or not-the-user's identity (e.g., “Them”- or “Other”-related words such as “They”, “Their”, “He”, “She”, “Him”, or “Her”). The respondent sorts each stimulus that appears in the center of the display 104 into the appropriate category by activating an associated input of the electronic input mechanism 110. For instance, the electronic input mechanism 110 can be a keyboard or keypad, and the associated input can be a left-hand or right-hand key (e.g., “E” or “I” on a computer keyboard) to correspond with the left side and right side of the display 104. This process is repeated for several trials (typically twenty), and the time it takes the respondent to sort each stimulus is recorded by the system.

The second task is “attribute concept practice”. The test-taker completes a sorting procedure similar to the first task, with attribute concept stimuli related to violence or extremism and not-violence or not-extremism. “Extremism” (or a related word, such as “Violence” or “Terrorism”) now appears as a category heading in the upper left of the display 104, and “Not Extremism” (or “Not Violence”, “Not Terrorism”, or another word expressing the concept of being opposed or unrelated to extremism, such as “America” or “Neutral”) appears as a category heading in the upper right. In the center of the display 104 appears a randomized sample from a group of stimuli related to the concepts of violence or extremism (e.g., in assessing affinity for terrorism, images of the World Trade Center collapsing, Osama bin Laden, flags of terrorist organizations, black-masked soldiers) or not-violence or not-extremism (e.g., in assessing affinity for terrorism, images related to the concept of “America”, such as the US flag or the Statue of Liberty, or images of “Neutral” concepts, such as everyday things, like a puppy, lollipop, or school bus; the subject's native culture, like well-known native landmarks or traditional foods or clothing; or international culture, like world-famous landmarks, people in their native dress, or national flags). The test-taker sorts each stimulus that appears in the center of the display 104 into the appropriate category by activating the associated input mechanism. This process is repeated for several trials (typically twenty), and the time it takes the respondent to sort each stimulus is recorded by the system.

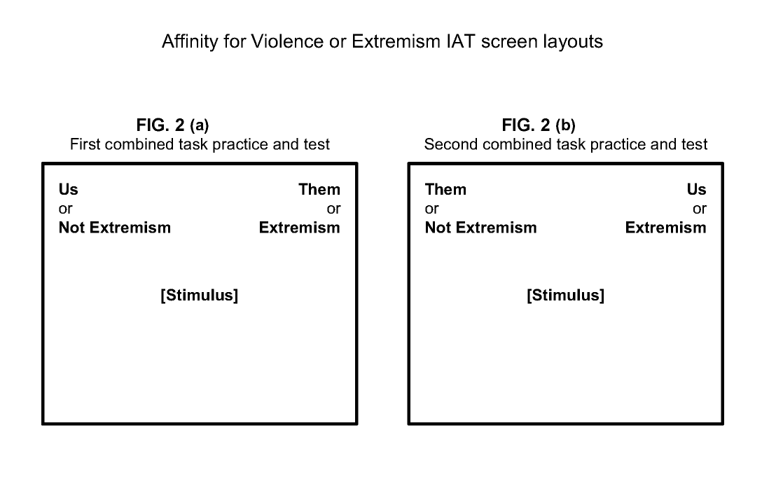

The third task, “first combined task practice”, combines both the target and attribute concepts from the first two tasks. “Us or Not Extremism” (or related terms) appear in the upper left of the display 104 as category headings, while “Them or Extremism” (or related terms) appear in the upper right as category headings. In the center of the display 104 appears a randomized sample from the four sets of stimuli used in the first two tasks associated with or related to the concepts of the subject's identity, not-the-subject's-identity, extremism, and not-extremism. The test-taker sorts each stimulus that appears in the center of the display 104 into the appropriate category by activating the associated input mechanism: for example, the left-hand key if the stimulus is associated with the “Us” and “Not Extremism” categories, and the right-hand key if it is associated with the “Them” and “Extremism” categories. This process is repeated for several trials (typically twenty to forty), and the time it takes the respondent to sort each stimulus is recorded by the system. The fourth task is the “first combined task test”. It repeats the third task, but with more trial repetitions (typically forty), and the time it takes the respondent to sort each stimulus is recorded by the system. FIG. 2 (a) illustrates the screen layout for the first combined task practice and test.

The fifth task is “target concept reversal practice”. It repeats the first task, but with the position of the two target concept category headings reversed: for instance, consistent with the example above, “Them” is now in the upper left and “Us” in the upper right of the display 104. The number of trials of the fifth task is typically doubled from the first task (e.g., to forty), and the time it takes the respondent to sort each word is recorded by the system.

The sixth task is the “second combined task practice”. It repeats the third task (including the number of trials), except that the target concept headings are reversed: “Them or Not Extremism” is now in the upper left of the display 104, “Us or Extremism” in the upper right. The time it takes the respondent to sort each word is recorded by the system.

The seventh task, the “second combined task test”, repeats the sixth task but with more trials (typically forty). The time it takes the respondent to sort each word is recorded by the system. FIG. 2 (b) illustrates the screen layout for the second combined task practice and test.

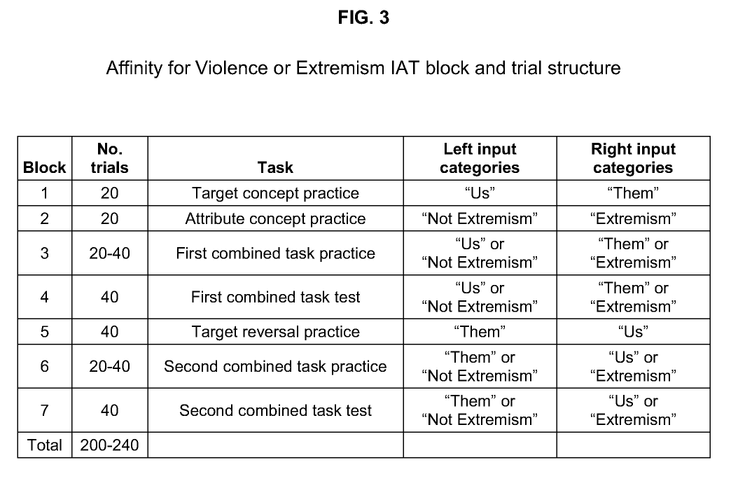

The table in FIG. 3 summarizes the block and trial structure, and the target and attribute category headings for each block, of the Affinity for Violence or Extremism IAT.

If the user implicitly associates each of the user's-identity and not-the-user's-identity target concepts with each of the violence or extremism and not-violence or not-extremism attribute concepts to differing degrees, the pairing reflecting the stronger association should be easier for the participant. For example, if participants have an affinity for extremism, they will be able to sort the stimuli into their associated categories more quickly when “Us” and “Extremism” responses, and “Them” and “Not Extremism” responses, are paired together than when “Us” and “Not Extremism”, and “Them” and “Extremism” responses are paired.

A measure of the test subject's implicit bias, known as the “TAT effect”, is calculated from the response times recorded by the system. The TAT effect for the Affinity for Violence or Extremism TAT indicates the strength of the test subject's associations of his or her self with not-violence or not-extremism and of others with violence or extremism, relative to the strength of the subject's associations of others with not-violence or not-extremism and of his or herself with violence or extremism. A basic scoring methodology, commonly referred to as the “conventional algorithm”, entails the following steps:
1. Use data only from the test blocks (4 and 7).
2. Drop the first two trials of each block.
3. Retain error-trial latencies in the analyzed data.
4. Recode latencies outside of a lower (300 milliseconds) and upper (3,000 milliseconds) boundaries to those boundary values.
5. Log-transform latencies.
6. Compute the average of the recoded, log-transformed latencies for blocks 4 and 7.
7. The TAT effect is equal to the difference in the two averages (block 4 minus block 7).

An improved scoring algorithm, demonstrated to have superior psychometric properties to a wide variety of alternative approaches, is known as the “D score”. This method differs from the conventional algorithm by using more of the recorded data and not log-transforming them, and in its treatment of trials with errors and large latencies. The D score algorithm consists of the following steps:
1. Use data from all four combined task blocks (3, 4, 6 and 7).
2. Remove trials with latencies greater than 10,000 milliseconds.
3. Compute the mean of all correct response times for each of the four blocks.
4. Compute one pooled standard deviation for all trials (correct and incorrect) in blocks 3 and 6, and another for blocks 4 and 7.
5. Replace each error latency with its block mean (computed in Step 3)+600 milliseconds.
6. Average the resulting values (including the recoded error latencies) for each of the four blocks.
7. Compute the two differences between blocks 6 and 3, and between blocks 7 and 4.
8. Divide each difference by its associated pooled-trials standard deviation from Step 4.
9. The TAT effect D score is equal to the average of the two quotients calculated in Step 8.

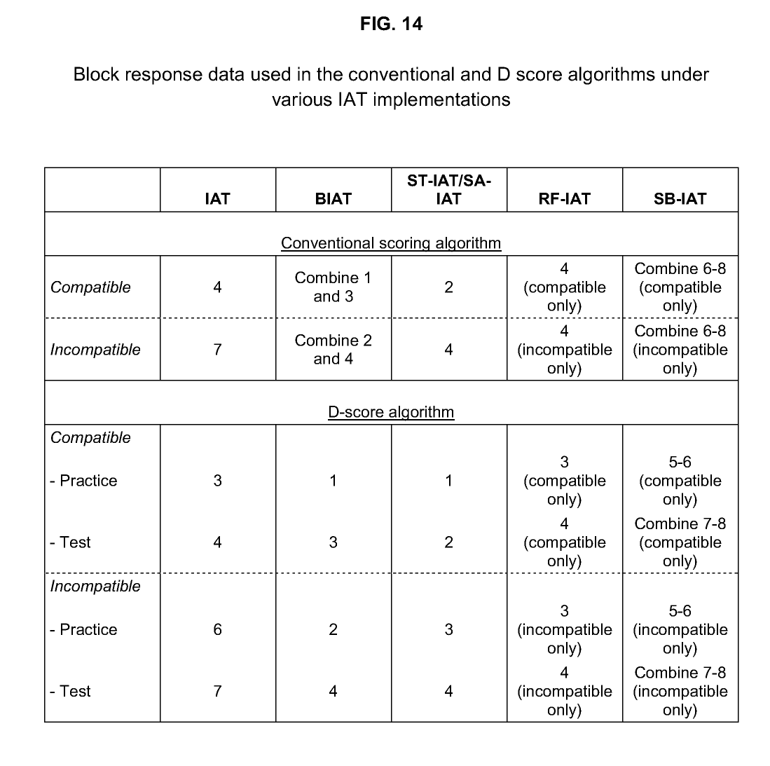

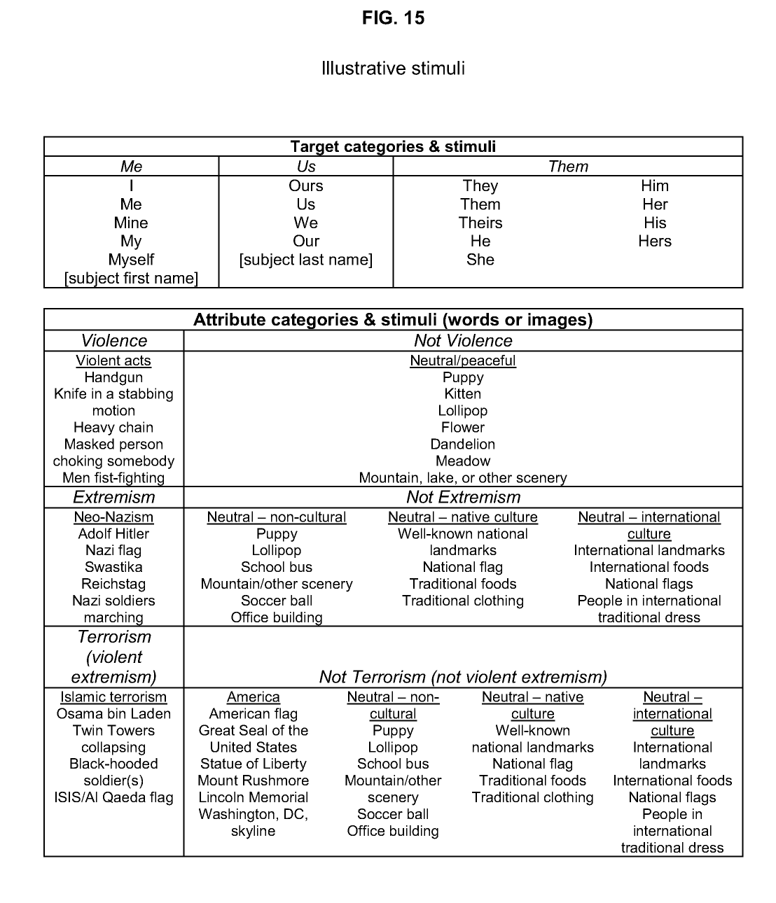

The table in FIG. 14 (at the end of this document) summarizes the block response data used in calculating the TAT effect under each scoring algorithm.

The D score algorithm generates a score ranging from −2 to +2. For the Affinity for Violence or Extremism TAT, a score of −2 would indicate that the test subject has strong associations between his or her self and violence or extremism and of others with not-violence or not-extremism, relative to the subject's associations of others with violence or extremism and of his or herself with not-violence or not-extremism.

A second implementation of the Affinity for Violence or Extremism TAT uses a shorter version of the TAT known as the “Brief TAT” (BIAT). The BIAT takes less time to administer than the standard TAT while retaining its predictive validity. The Brief TAT removes the target and attribute concept practice blocks to reduce the time needed to administer the test. In addition, it provides target or attribute concept category headings for only one of the potential responses (left- or right-sided); the heading for the other response is simply “Anything else” or a phrase of similar meaning. The Affinity for Violence or Extremism Brief TAT involves four tasks:

The first task is the “first combined task”. “Us/Not Extremism” (or related terms) appear in the upper right of the display 104, while “Anything else” (or related words) appears in the upper left. In the center of the display 104 appears a randomized sample from the four groups of stimuli associated with or related to the concepts of the user's identity, not-the-user's-identity, violence or extremism, and not-violence or not-extremism (the category headings and stimuli are the same as those described above for the Affinity for Violence or Extremism IAT). The test-taker sorts each stimulus that appears in the center of the display 104 into the appropriate category by activating the associated input mechanism: for example, the right-hand key if the stimulus is associated with either of the “Us” or “Not Extremism” categories, and the left-hand key otherwise. This process is repeated for several trials (typically twenty to twenty-four), and the time it takes the respondent to sort each stimulus is recorded by the system.

The “second combined task” repeats the first task, but with “Us” (or a related term) replacing “Them” (or the related term used in the first task) in the upper right category heading. The test-taker presses the right-hand key for each stimulus that is associated with the “Them” or “Not Extremism” category, and the left-hand key otherwise.

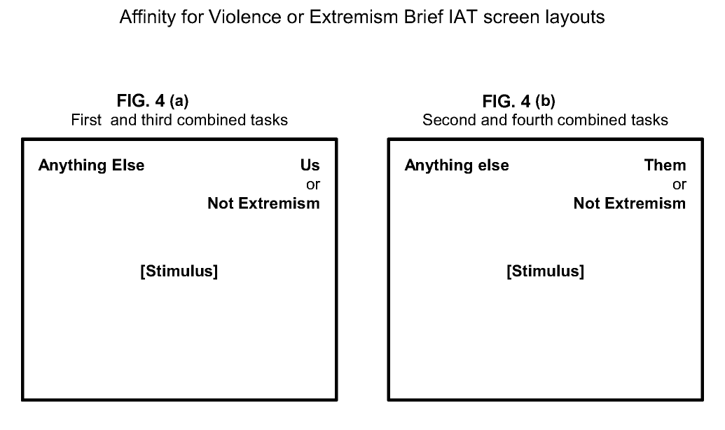

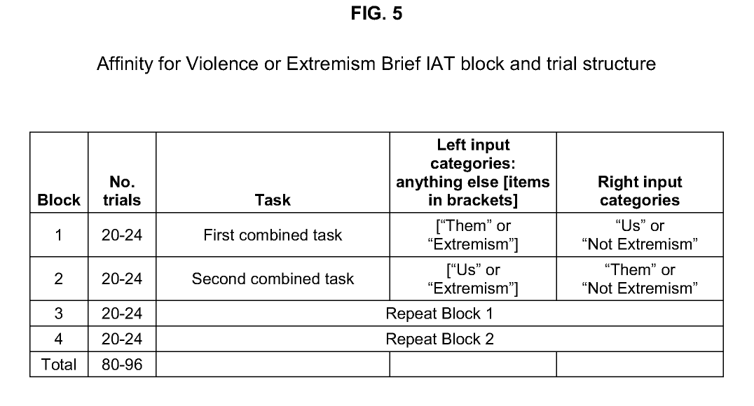

The “third combined task” repeats the first task. FIG. 4 (a) illustrates the screen layout for the first and third combined tasks. The “fourth combined task” repeats the second task. FIG. 4 (b) illustrates the screen layout for the second and fourth combined tasks. FIG. 5 summarizes the block and trial structure, and the target and attribute category headings for each block, of the Affinity for Violence or Extremism Brief IAT.

Alternative implementations of the Affinity for Violence or Extremism BIAT include reversing the inputs (i.e., right-sided response for “Anything else”), rearranging the ordering of the blocks, and/or substituting “Extremism” (or a related term) and its corresponding responses in all category headings where “Not Extremism” is used in the above description.

The IAT effect for the Affinity for Violence or Extremism Brief IAT can be computed using either scoring algorithm described above, although the D score is preferred. Under the conventional algorithm, the data recorded in blocks 1 and 3 under the BIAT procedure are combined and substituted for block 4, and blocks 2 and 4 are combined and substituted for block 7. Using the D score algorithm, blocks 1, 3, 2 and 4 are substituted for blocks 3, 4, 6, and 7, respectively. The table in FIG. 14 (at the end of this document) summarizes the block response data used in calculating the IAT effect under each scoring algorithm for the Brief IAT.

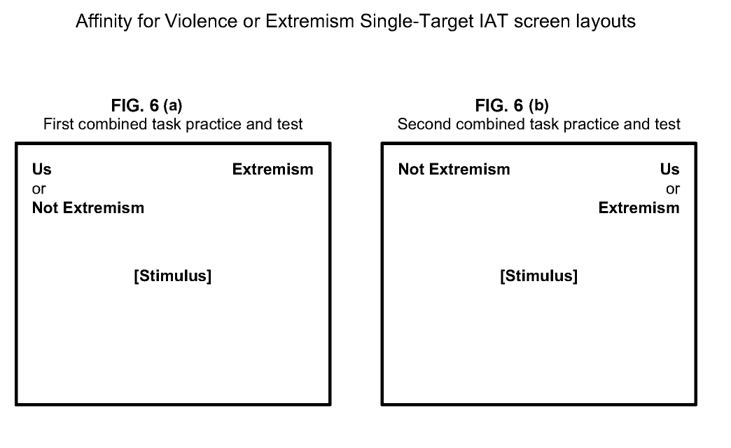

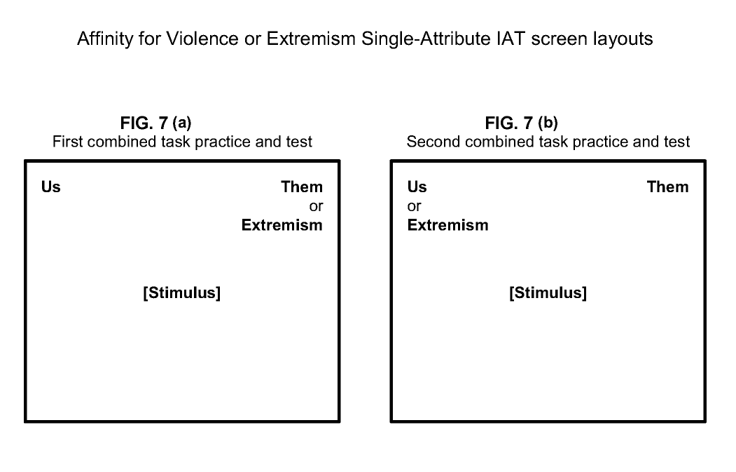

Third and fourth implementations of the Affinity for Violence or Extremism IAT use only a single target or attribute concept, respectively. These implementations are useful when the target or attribute concept does not have an obvious opposite (e.g., terrorism) or has associations beyond those the IAT is intended to measure (e.g., most positive-valence attributes in relation to the self). In these implementations, the category headings for the target or attribute concept in question are simply not presented, and their respective stimuli are replaced with another randomized sample from the remaining attribute or target concept. The diagrams in FIG. 6 and FIG. 7 below illustrate the screen layouts of the Affinity for Violence or Extremism “Single-Target IAT” (ST-IAT) and “Single-Attribute IAT” (SA-IAT), respectively.

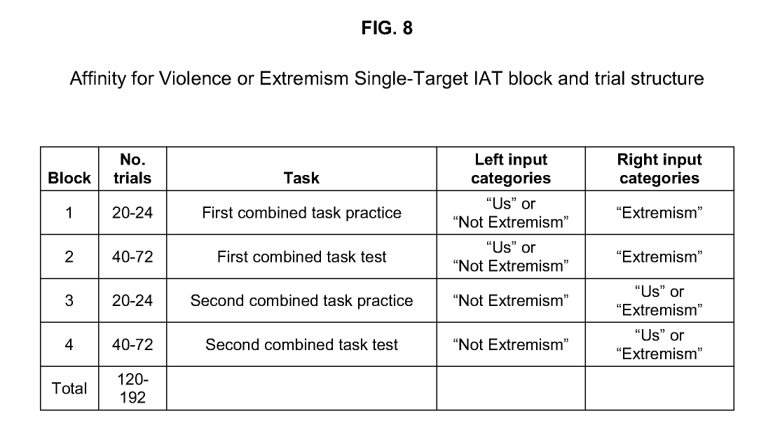

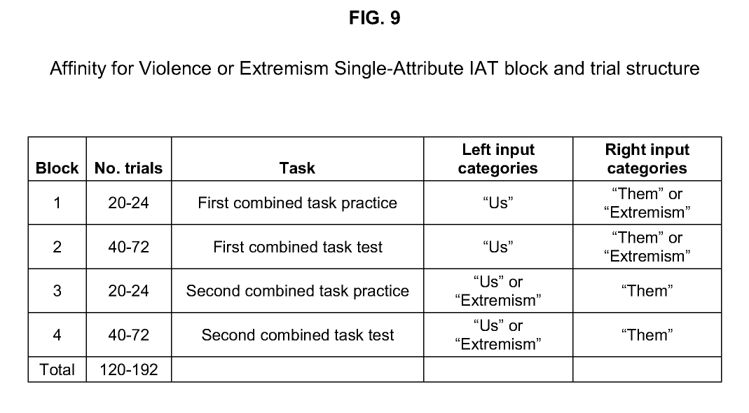

The ST-IAT and SA-IAT are typically implemented without the three target and attribute concept practice blocks included in the original IAT procedure, and the number of trials in the test blocks is frequently increased. The tables in FIG. 8 and FIG. 9 summarize the block and trial structure, and the target and attribute category headings for each block, of the Affinity for Violence or Extremism Single-Target and Single-Attribute IATs, respectively.

The IAT effect for both the Single-Target and Single-Attribute IATs can be computed using either scoring algorithm described above, although the D score is preferred. Under the conventional algorithm, the data recorded in blocks 2 and 4 are substituted for blocks 4 and 7. Using the D score algorithm, blocks 1, 2, 3 and 4 are substituted for blocks 3, 4, 6, and 7, respectively. The table in FIG. 14 summarizes the block response data used in calculating the IAT effect under each scoring algorithm for both the ST-IAT and SA-IAT.

A fifth implementation of the Affinity for Violence or Extremism TAT entails administering the third and fourth implementations in succession (#3 followed by #4, or vice versa) and averaging their scores or otherwise processing the collected response-time data into a combined metric, specifically to mitigate the influence of most people's positive self-concept.

Two other implementations of the TAT randomly require the user to randomly alternate responses in sorting stimuli to categories, to prevent what is known as “recoding”. Recoding refers to sorting the presented stimuli not in terms of the nominal definitions of their respective target and/or attribute categories, but instead on the basis of some other feature that discriminates between both the two target categories and the two attribute categories. Recoding typically helps to simplify one of the two combined tasks of an TAT, thereby skewing the results.

A sixth implementation of the TAT, known as the “Recoding-Free TAT” (TAT-RF), randomly shuffles the category headings to reduce recoding. It consists of four tasks:

The first task is “attribute concept practice”. “Extremism” and “Not Extremism” (or related terms) appear in the upper left and upper right of the display 104, respectively, as category headings. In the center of the display 104 appears a stimulus randomly selected from either of the two groups of stimuli associated with or related to each of these two concepts. The respondent sorts each stimulus into the appropriate category by activating the associated input of the electronic input mechanism 110. This process is repeated for several trials (typically sixteen), and the time it takes the respondent to sort each stimulus is recorded by the system.

In the second task, “target concept practice”, the test-taker completes a sorting procedure similar to the first task. For each trial, one of the target concepts “Us” or “Them” (or related terms) is randomly selected to appear in the upper left corner of the display 104; the unselected category appears in the upper right corner. In the center of the display 104 appears a stimulus randomly selected from either of the two groups of stimuli associated with or related to each of these two concepts. The respondent sorts each stimulus into the appropriate category by activating the associated input of the electronic input mechanism 110. This process is repeated for several trials (typically sixteen), and the time it takes the respondent to sort each stimulus is recorded by the system.

The third task, “combined task practice”, combines the first two tasks. In the upper left corner, “Extremism” and a random alteration between “Us” and “Them” (or whatever related terms were used in the first and second tasks) are displayed as category headings. In the upper right corner, “Not Extremism” and whichever of “Us” and “Them” (or whatever related terms were used in the first and second tasks) is not displayed in the upper left corner are displayed as category headings. In the center of the display appears a stimulus randomly selected from one of the four groups of stimuli associated with each of these four concepts used as category headings. The respondent sorts each stimulus into the appropriate category by activating the associated input of the electronic input mechanism 110. This process is repeated for several trials (typically thirty-two), and the time it takes the respondent to sort each stimulus is recorded by the system.

The fourth task, “combined task test”, follows the same procedure as the third task, except the number of trials is increased, typically to 128.

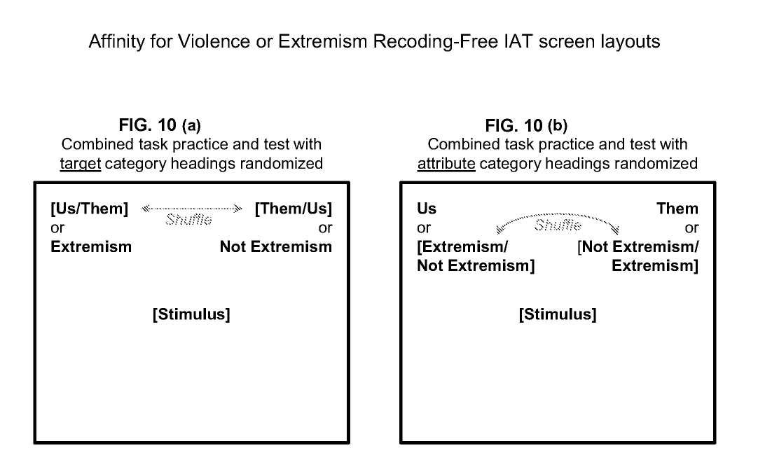

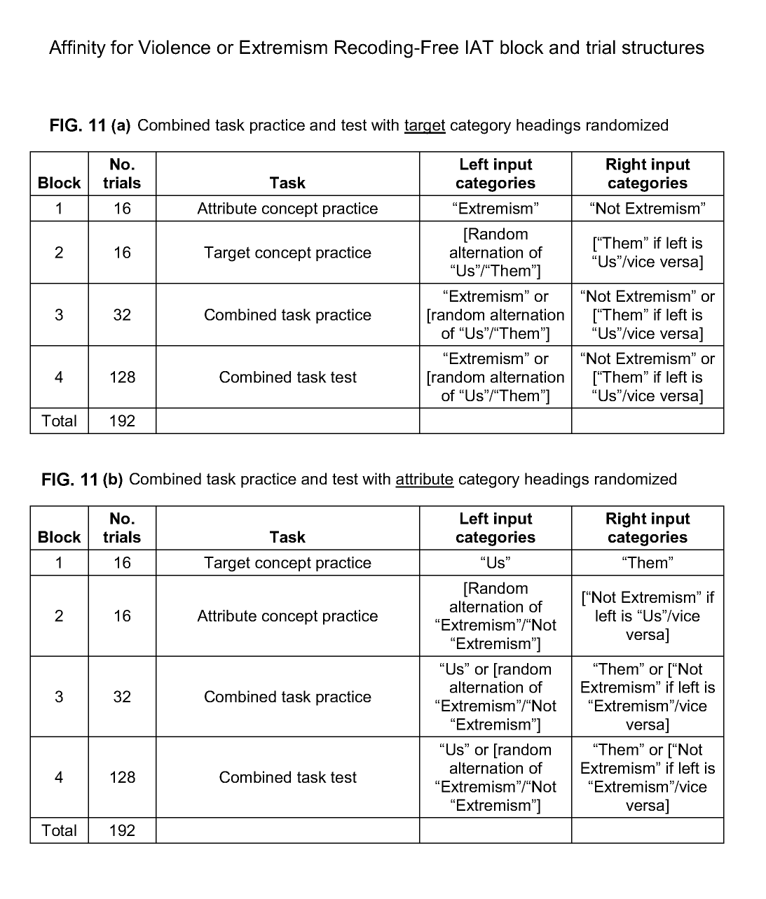

The Recoding-Free IAT can also be implemented by randomly shuffling the attribute (instead of the target) concept category headings and the corresponding presentment of stimuli. The diagrams in FIG. 10 (a) and FIG. 10 (b) below illustrate the screen layouts of these two implementations of the Affinity for Violence or Extremism Recoding-Free IAT. FIG. 11 summarizes the block and trial structures, and the target and attribute category headings for each block, of these two implementations of the Affinity for Violence or Extremism Recoding-Free IAT. A further modification of the Recoding-Free IAT entails reversing the target and attribute concept category headings.

A seventh implementation, also for minimizing recoding, is the “Single-Block IAT” (SB-IAT). The SB-IAT divides the display 104 into upper and lower halves, with the placement of the target or attribute category headings alternating between the left and right sides in each half. Stimuli are randomly presented in either the upper or lower half, with the placement indicating the category headings against which they are to be sorted by the user. The Affinity for Violence or Extremism Single-Block IAT consists of eight tasks:

The first task is “target concept practice in the upper screen”. “Us” and “Them” (or related terms) appear as category headings in the upper left and upper right of the display, respectively. In the center of the display 104 appears a stimulus randomly selected from either of the two groups of stimuli associated with or related to each of these two concepts. The respondent sorts each stimulus into the appropriate category by activating the associated input of the electronic input mechanism 110: for example, the left-hand key if the stimulus is associated with the “Us” category, the right-hand key if it is associated with the “Them” category. This process is repeated for several trials (typically twenty-six), and the time it takes the respondent to sort each stimulus is recorded by the system.

The second task, “target concept practice in the lower screen”, repeats the first task, but with the position of the two target concept category headings reversed and placed near the bottom of the display 104: “Us” and “Them” (or whatever terms were used in the first task) are now in the lower right and lower left, respectively. Stimuli are presented just below the center of the screen.

The third task is “combined target practice in the upper and lower screens”. “Us” appears in both the upper left and lower right of the display, and “Them” appears in the upper right and lower left. Stimuli associated with or related to these two categories are presented randomly either just above or just below a short horizontal line in the center of the display 104. If the stimulus appears above the line, the respondent sorts it according to the category headings at the top of the screen; below the line, according to the category headings at the bottom of the screen. This process is repeated for several trials (typically twenty-six), and the time it takes the respondent to sort each stimulus is recorded by the system.

The fourth task is “attribute concept practice in the upper and lower screens”. “Extremism” (or a related term) appears on the left side of the display 104, vertically in the middle; “Not Extremism” (or a related term) appears on the right side, opposite. Stimuli associated with or related to these two categories are presented randomly either just above or below a short horizontal line in the center of the screen. The respondent sorts each stimulus according to the category headings on each side of the screen. This process is repeated for several trials (typically twenty-six), and the time it takes the respondent to sort each stimulus is recorded by the system.

The fifth task, the “first combined test”, combines the third and fourth tasks. “Us” appears in both the upper left and lower right of the display 104, “Them” in the upper right and lower left; “Extremism” appears on the screen's left side, vertically in the middle, “Not Extremism” on the right side, opposite. Stimuli associated with or related to these four categories are presented randomly either just above or just below a short horizontal line in the center of the screen. If a stimulus appears above the line, the respondent must sort it according to the category headings at the top and sides of the screen; below the line, according to the category headings at the bottom and sides of the screen. This process is repeated for several trials (typically fifty-two), and the time it takes the respondent to sort each stimulus is recorded by the system.

The sixth through eighth tasks repeat the fifth.

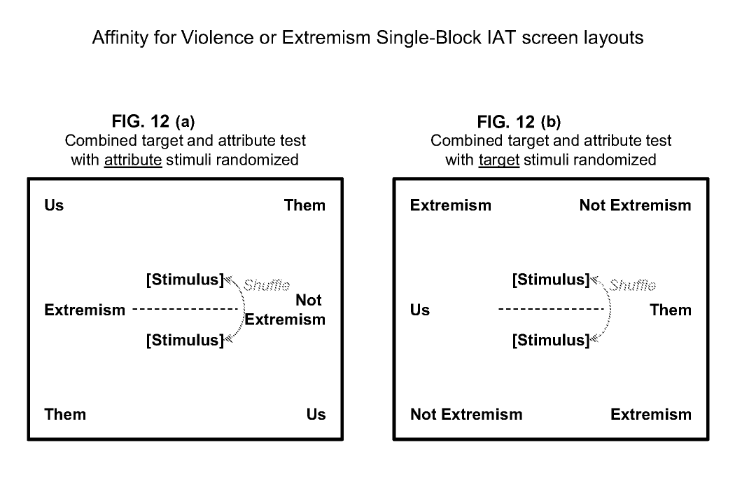

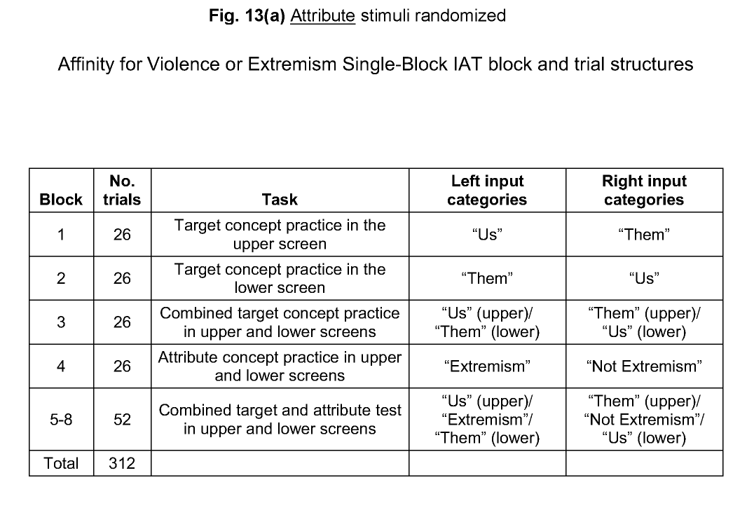

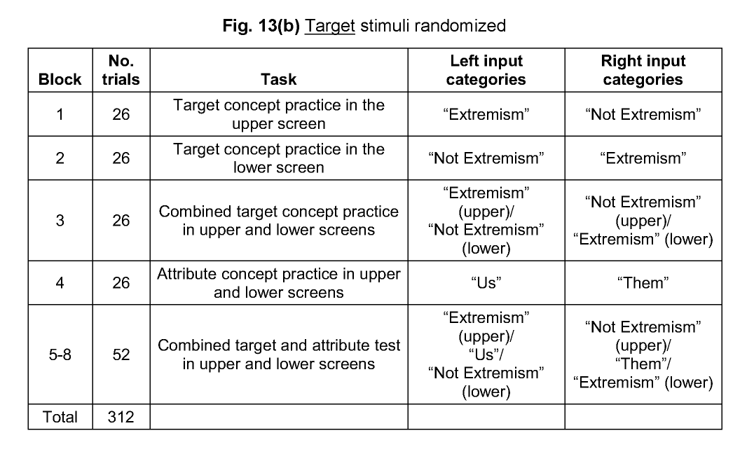

The Single-Block IAT can also be implemented by reversing the placement of the target and attribute concept category headings and the corresponding presentment of stimuli. FIG. 12 (a) and FIG. 12 (b) illustrate the screen layouts, and FIG. 13 (a) and FIG. 13 (b) summarize the block and trial structure, of these two versions of the Affinity for Violence Extremism Single-Block IAT.

The IAT effect for the Affinity for Violence or Extremism Single-Block IAT can be computed using either scoring algorithm described above, although the D score is preferred. Under both algorithms, the data recorded in blocks 5-8 are separated into “compatible” (e.g., “Extremism or Them” and “Not Extremism or Us”) and “incompatible” (e.g., “Extremism or Us” and “Not Extremism or Them”) responses. Under the conventional algorithm, the compatible and incompatible response data in blocks 6, 7 and 8 are combined and substituted for the data in blocks 4 (compatible) and 7 (incompatible), respectively. Under the D score algorithm, the compatible and incompatible response data in blocks 5 and 6 are combined and substituted for the data in blocks 3 and 6, respectively; the compatible and incompatible response data in blocks 7 and 8 are combined and substituted for the data in blocks 4 and 7, respectively. The table in FIG. 14 (at the end of this document) summarizes the block response data used in calculating the IAT effect under each scoring algorithm for the Affinity for Violence or Extremism Recoding-Free IAT.

One or more aspects or features of the subject matter described herein can be realized in digital electronic circuitry, integrated circuitry, specially designed application specific integrated circuits (ASICs), field programmable gate arrays (FPGAs) computer hardware, firmware, software, and/or combinations thereof. These various aspects or features can include implementation in one or more computer programs that are executable and/or interpretable on a programmable system including at least one programmable processor, which can be special or general purpose, coupled to receive data and instructions from, and to transmit data and instructions to, a storage system, at least one input device, and at least one output device. The programmable system or computing system may include clients and servers. A client and server are generally remote from each other and typically interact through a communication network. The relationship of client and server arises by virtue of computer programs running on the respective computers and having a client-server relationship to each other.

These computer programs, which can also be referred to as programs, software, software applications, applications, components, or code, include machine instructions for a programmable processor, and can be implemented in a high-level procedural and/or object-oriented programming language, and/or in assembly/machine language. As used herein, the term “machine-readable medium” refers to any computer program product, apparatus and/or device, such as for example magnetic discs, optical disks, memory, and Programmable Logic Devices (PLDs), used to provide machine instructions and/or data to a programmable processor, including a machine-readable medium that receives machine instructions as a machine-readable signal. The term “machine-readable signal” refers to any signal used to provide machine instructions and/or data to a programmable processor. The machine-readable medium can store such machine instructions non-transitorily, such as for example as would a non-transient solid-state memory or a magnetic hard drive or any equivalent storage medium. The machine-readable medium can alternatively or additionally store such machine instructions in a transient manner, such as for example as would a processor cache or other random access memory associated with one or more physical processor cores.

To provide for interaction with a user, one or more aspects or features of the subject matter described herein can be implemented on or generated and rendered by a computer having a display device, such as for example a cathode ray tube (CRT), a liquid crystal display (LCD) or a light emitting diode (LED) monitor for displaying information to the user and a keyboard and a pointing device, such as for example a mouse or a trackball, by which the user may provide input to the computer. Other kinds of devices can be used to provide for interaction with a user as well. For example, feedback provided to the user can be any form of sensory feedback, such as for example visual feedback, auditory feedback, or tactile feedback; and input from the user may be received in any form, including, but not limited to, acoustic, speech, or tactile input. Other possible input devices include, but are not limited to, touch screens or other touch-sensitive devices such as single or multi-point resistive or capacitive trackpads, voice recognition hardware and software, optical scanners, optical pointers, digital image capture devices and associated interpretation software, and the like.

The subject matter described herein can be embodied in systems, apparatus, methods, and/or articles depending on the desired configuration. The implementations set forth in the foregoing description do not represent all implementations consistent with the subject matter described herein. Instead, they are merely some examples consistent with aspects related to the described subject matter. Although a few variations have been described in detail above, other modifications or additions are possible. In particular, further features and/or variations can be provided in addition to those set forth herein. For example, the implementations described above can be directed to various combinations and subcombinations of the disclosed features and/or combinations and subcombinations of several further features disclosed above. In addition, the logic flows depicted in the accompanying figures and/or described herein do not necessarily require the particular order shown, or sequential order, to achieve desirable results. The test can also be implemented in any language, in addition to English.

What is claimed is:

1. A computer-implemented method comprising:
generating, by one or more processors of a machine, a series of sorting tasks for a user of a computer associated with the machine, the computer including an output device and an input device, each of the series of sorting tasks comprising a plurality of digital representations of stimuli associated with either relatedness to the user or violence or extremism;
providing, by the one or more processors, at least two digital representations of association categories as separate outputs from the output device, at least one of the at least two digital representations of the association categories being associated with the user's relatedness, and at least one other of the at least two digital representations of the association categories being associated with the user's tendency for violence or extremism, each of the separate outputs being associated with an input actuator of the input device;
executing, by the one or more processors, a sequence of two or more trials, each trial comprising:
providing, by the one or more processors, a randomly-selected digital representation of a stimulus to the output device in proximity to the separate outputs that provide the at least two digital representations of the association categories, the stimulus being associated with either the user's relatedness or violence or extremism represented by the at least two digital representations of the association categories;
receiving, by the one or more processors, a selection by the user from the input actuator of the input device in response to the stimulus, the selection indicating a category with which the user associates the stimulus; and
recording, by the one or more computer processors, a time between providing the randomly-selected digital representation of the stimulus and receiving the selection by the user via the input device; and
calculating, by the one or more computer processors, a score reflecting the strength of the user's implicit association between one pair of relatedness and violence or extremism categories, relative to the strength of the user's implicit association between another, different pair of relatedness and violence or extremism categories, the score being based at least partially on the time between providing the at least two randomly-selected digital representations of stimuli and receiving the selection by the user via the input device for each of the trials in the sequence of two or more trials.

2. A computer-implemented method in accordance with claim 1, wherein the digital representations of stimuli associated with violence or extremism includes words or images associated with acts of terrorism.

3. A computer-implemented method in accordance with claim 1, wherein the randomly-selected digital representation of the stimulus is provided to a display of the output device spatially equidistant on the display to the separate outputs that provide the at least two digital representations of the association categories.

4. A computer-implemented method in accordance with claim 1, wherein the input actuator of the input device includes at least two keys of a keyboard.

5. A computer-implemented method in accordance with claim 1, wherein the input actuator of the input device includes an actuator of a peripheral input device.

6. A computer-implemented method in accordance with claim 1, wherein the sequence of the two or more trials includes at least twenty trials.

7. A computer-implemented method in accordance with claim 1, further comprising outputting, by the one or more computer processors, the score to the output device.

8. A computer-implemented method in accordance with claim 1, further comprising outputting, by the one or more computer processors, the score to a communications network coupled with the machine.

9. A non-transitory computer program product storing instructions that, when executed by at least one programmable processor, cause the at least one programmable processor to perform operations comprising:
generate a series of sorting tasks for a user of a computer associated with the machine, the computer including an output device and an input device, each of the series of sorting tasks comprising a plurality of digital representations of stimuli associated with either relatedness to the user or violence or extremism;
provide at least two digital representations of association categories as separate outputs from the output device, at least one of the at least two digital representations of the association categories being associated with the user's relatedness, and at least one other of the at least two digital representations of the association categories being associated with the user's tendency for violence or extremism, each of the separate outputs being associated with a separate input of the input device;
execute a sequence of two or more trials, each trial comprising:
providing a randomly-selected digital representation of a stimulus to the output device in proximity to the separate outputs that provide the at least two digital representations of the association categories, the stimulus being associated with either the user's relatedness or violence or extremism represented by the at least two digital representations of the association categories;
receiving a selection by the user from one of the separate inputs of the input device in response to the stimulus, the selection indicating a category with which the user associates the stimulus; and
recording a time between providing the randomly-selected digital representation of the stimulus and receiving the selection by the user via the input device; and
calculate a score reflecting the strength of the user's implicit association between one pair of relatedness and violence or extremism categories, relative to the strength of the user's implicit association between another, different pair of relatedness and violence or extremism categories, the score being based at least partially on the time between providing the at least two randomly-selected digital representations of stimuli and receiving the selection by the user via the input device for each of the trials in the sequence of two or more trials.

10. A system comprising:
at least one programmable processor; and
a machine-readable medium storing instructions that, when executed by the at least one processor, cause the at least one programmable processor to perform operations comprising:
generating a series of sorting tasks for a user of a computer associated with the machine, the computer including an output device and an input device, each of the series of sorting tasks comprising a plurality of digital representations of stimuli associated with either relatedness to the user or violence or extremism;
providing at least two digital representations of association categories as separate outputs from the output device, at least one of the at least two digital representations of the association categories being associated with the user's relatedness, and at least one other of the at least two digital representations of the association categories being associated with the user's tendency for violence or extremism, each of the separate outputs being associated with a separate input of the input device;
executing a sequence of two or more trials, each trial comprising:
providing a randomly-selected digital representation of a stimulus to the output device in proximity to the separate outputs that provide the at least two digital representations of the association categories, the stimulus being associated with either the user's relatedness or violence or extremism represented by the at least two digital representations of the association categories;
receiving a selection by the user from one of the separate inputs of the input device in response to the stimulus, the selection indicating a category with which the user associates the stimulus; and
recording a time between providing the randomly-selected digital representation of the stimulus and receiving the selection by the user via the input device; and
calculating by the one or more computer processors, a score reflecting the strength of the user's implicit association between one pair of relatedness and violence or extremism categories, relative to the strength of the user's implicit association between another, different pair of relatedness and violence or extremism categories, the score being based at least partially on the time between providing the at least two randomly-selected digital representations of stimuli and receiving the selection by the user via the input device for each of the trials in the sequence of two or more trials.
